(19) United States
(12) Patent Application Publication
(10) Pub. No.: US 2014/0164888 A1
(43) Pub. Date: Jun. 12, 2014

(54) SYSTEMS AND METHODS FOR AUTOMATED DESTINATION MULTIMETRIC RATING AND SCORECARD

(71) Applicants: Michella Lynn Schaefer, Tuscon, AZ (US); Robert Shaw West, III, Chapel Hill, NC (US); Dwayne Charles Fry, Raleigh, NC (US)

(72) Inventors: Michella Lynn Schaefer, Tuscon, AZ (US); Robert Shaw West, III, Chapel Hill, NC (US); Dwayne Charles Fry, Raleigh, NC (US)

(21) Appl. No.: 13/712,684

(22) Filed: Dec. 12, 2012

(51) Int. Cl. G06F 17/22

(52) U.S. Cl. CPC G06F 17/2247
USPC 715/201

(57) ABSTRACT

Systems and methods for destination rating and ranking for a multiplicity of business entities in a related geographic area using a virtual scorecard.

### BACKGROUND OF THE INVENTION

1. Field of the Invention

The present invention relates generally to systems and methods for destination rating, and, more particularly, to systems and methods for automated destination rating and ranking for a multiplicity of business entities in a related geographic area using a virtual scorecard.

2. Description of the Prior Art

In general, it is known in the relevant prior art to provide systems and methods for rating a single destination business at one location. By way of example, travel and/or reservation sites provide for users to input comments and/or a rating number (e.g., on a scale of zero to 5, on a scale of zero to 20, or zero to 100) following their visit to a single destination business at one location, such as a hotel, restaurant, etc. Web-based inputs and displays are provided commercially at www.yelp.com, which provides for users to search for single specific business types at a predetermined location, such as a city, and to provide feedback and ratings of their visit thereto. Businesses are categorized and grouped according to function but are rated completely independently of other businesses in the same or different categories for the same predetermined location (city). Also, www.tripadvisor.com includes destination ratings.

By way of example, relevant prior art patent documents include the following:

U.S. Pat. No. 5,948,040 for “Travel reservation” by inventors DeLorme, et al., issued Sep. 7, 1999, describes a website allowing users to select ‘Who? What? When? and How?’ for vacation planning by drop-down selection menus, wherein a points-of-interest database is provided that is searchable by the users. The system claims a travel reservation information and planning system including a computer, a geographic and topical database, and a means for the user to relay one or more inputs to travel, travel planning, and activities associated with travel, and provides a geographic subsystem that provides points of interest based upon the user's location or user input data.

US Patent Application Publication No. 20020091535 for “System and method for selecting a vacation destination and accommodation” by inventors Rendall et al., published Jul. 11, 2002, discloses an interactive vacation destination selection system that is back- and front-ended, wherein the front end assesses what a consumer wants in a vacation destination, and the back end identifies criteria that may be important to the consumer. This publication also describes an interactive vacation destination selection system that includes a computer, terminal communication with a computer, display, and user input device. Furthermore, this publication describes a method including the steps of presenting to a user inquiries for criteria for a vacation destination without requesting the user to indicate a specific destination, and determining from the input information at least one vacation destination recommendation for the user.

US Patent Application Publication No. 20010051876 for “System and method for personalizing, customizing, and distributing geographically distinctive products and travel information over the internet” by inventors Siegel et al., published Dec. 13, 2001, describes a website-based program to select content by categorizing attributes of a user in a user database that can be used to customize travel information, and provides geographic location and prioritization of the content elements associated with the identified geographic location, wherein the users are able to personalize their travel plans using the website based upon pre-selected content from pull-down menus with various content based on the travel destination. This publication further claims a method for using a computer for selecting content comprising the steps of categorizing attributes of a user in a database, categorizing contents elements in a content database, identifying geographic locations and identifying a user, and prioritizing content elements with identified geographic location for presentation to the identified users.

U.S. Pat. No. 5,732,398 for “Self-service system for selling travel-related services or products” by inventor Tagawa, issued Mar. 24, 1998, describes a self-service system of selling travel-related services by means of using an interactive travel service system that functions as a travel agent, wherein the website asks for user input to gain travel knowledge, such as whether the user is a first-time visitor, whether the user is otherwise familiar with the travel destination, and user's personal attributes such as family orientation, age, and preference for airline, lodgings, car rental companies, price range, and lifestyle. The system is used for self-service selling of travel-related services and products related to local visitor attractions at a destination area by means of an interactive electronic travel service system functioning like a travel agent, including a method of selling tours, cruises, and optional tours outside of a local area by means of an interactive electronic travel service system similar to a travel agent.

US Patent Application Pub. No. 20040102992 by inventor Tapsell for “Communicating data relating to a site having one or more visitor destinations,” published May 27, 2004, discloses a user registering for a site providing information about one or more visitor destinations, wherein the users are allowed to send and receive data related to various visitor destinations over a communication network having one or more visitor destinations, and computer code that when loaded to make a computer execute procedure allowing the user to send and receive data over a communication network related to a site having one or more visitor destinations.

US Patent Application Pub. No. 20050187808 by inventor Adamson, published Aug. 25, 2005, for “Integrated destination sales system with ASP-hosted member interface” describes an internet-based convention planning system that brings together clients, exhibitors, sponsor clients, and attendees, wherein all the clients are able to interact via a central website server and store the convention data. The publication includes disclosing a method of providing a computerized integrated sales system for destination events including the steps for a program able to receive a request for proposal (RFP) from a potential destination event organizer, requesting information from the convention visitor bureau (CVB), and having the CVB organization compile related information about the RFP and electronically publish it, where it can be regularly reviewed and updated by the members. It further describes steps of a member user electronic means notifying members, updating member user of changes made to the proposal, describing the software module hosted by the application service provider (ASP), and providing a customer webpage interface.

Additionally, websites having descriptions for visitor experience information include the following:

Www.tripadvisor.com provides a website that includes users' inputs to provide travel information for specific businesses at predetermined destinations for current travel planners using the website.

Www.yelp.com provides a website having user reviews and recommendations for restaurants, shopping, entertainment, automotive, beauty and spas, medical businesses, and other services for a city; each business entity is rated separately and individually from other entities within the same city, with a listing of the number of individual users that have rated each of the businesses, and wherein the rating of each business is on a scale of 1 to 5 stars, and may further include comments by the individual users that have rated each business.

Www.visitorexperience.org.uk is a website providing information on the United Kingdom (UK), country-specific visitor experience creation company.

Www.foe.org/cruise-report-card is a website that provides user-given grades on various cruise lines (single business entities).

Www.fd2s.com/2009/04/municipal-wayfinding-and-the-visitor-experience/ is a blog website providing information on municipal visitor experience.

None of the prior art references identified or known provide the functions, features, and benefits of the present invention, which addresses longstanding, unmet needs in the market.

### SUMMARY OF THE INVENTION

The present invention relates generally to systems and methods for destination ratings and rankings wherein the destination includes a multiplicity of business entities in a related geographic area using a virtual scorecard. Also, the destination ratings and rankings, the virtual scorecard, and comparative profiles for contributors (or users) and destinations are provided in the context of automated systems and methods provided with database and analytics accessible over at least one network.

Overall, the present invention provides systems and methods for a virtual scorecard reflecting visitor experience multimetric ratings of a destination, and may further provide for a virtual scorecard including at least one rating and at least one ranking, and improvements associated with a predetermined strategy, the improvements being specific to a destination, and wherein each of a multiplicity of destinations is unitarily and integrally rated for the overall destination, including consideration of more than one business entity within that singular rating for the destination.

It is an object of this invention to provide systems and methods for a scorecard including multimetric destination ratings wherein each of a multiplicity of destinations includes more than one geographic-specific business entity in a common location with each other, and wherein the destination rating is based upon visitor-experience-based evaluations having more than one criteria for rating each of the destinations.

It is an object of this invention to provide automated systems and methods for providing a scorecard for destination rating by a multiplicity of factors, including visitor experience-sharing provided through inputs associated with a plurality of user-based profiles and destination-based profiles stored in at least one database and server computer having a processor coupled with a memory, and an analytics engine operable thereon, with user access provided through a network via an interactive graphic user interface (GUI) on a display and in communication with the server(s).

Yet another object of this invention is to provide automated systems and methods for transforming a destination rating and ranking into a scorecard based upon a multimetric rating, wherein the rating includes visitor experience-sharing provided based upon data collection associated with user-based profiles and destination-based profiles stored in at least one database and server computer having a processor coupled with a memory, and an analytics engine operable thereon, with a multiplicity of contributors providing inputs for generating a multi-metric rating via a network connection and an interactive graphic user interface on a display and in communication with the server(s).

These and other aspects and objects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic diagram illustrating a virtualized computing network used in of one embodiment of the invention for automated systems and methods

FIG. 2 is a schematic diagram of an embodiment of the invention showing multiple criteria for visitor experience data collection

FIG. 3 is a schematic diagram of an embodiment of the invention illustrating a strategy map for visitor-focused destination balanced scorecard and standards-based factors for improvement.

FIG. 4 is a schematic diagram of an embodiment of the invention showing a standards table.

### DETAILED DESCRIPTION

Referring now to the drawings in general, the illustrations are for the purpose of describing a preferred embodiment of the invention and are not intended to limit the invention thereto. For the purposes of the present invention, visitors are people who experience a destination, which may include residents of the destination itself.

The present invention provides systems and methods for destination ratings and rankings wherein the destination includes a multiplicity of business entities in a related geographic area using a virtual scorecard. Also, the destination ratings and rankings, the virtual scorecard, and comparative profiles for contributors (or users) and for destinations are provided in the context of systems and methods provided with database and analytics accessible over at least one network.

Generally, without reference to an automated framework, the systems and methods for destination ratings and associated virtual scorecard provided according to the present invention include a multiplicity of destinations, wherein each of the destinations includes more than one geographic-specific business entity in a common location associated with each of the destinations. For the purposes of this application, and in accordance with the present invention, a destination is defined as a geographic location, which may be a city or a sub-component of a city, such as a neighborhood, zone, or other geographic region having a particular characteristic or set of characteristics that together form a predefined region, and that include a community of stakeholders having a physical presence in association with that particular geographic location. Furthermore, the destination is not defined by a single business entity; by distinction from the prior art, where a destination rating is considered for a single business entity, such as a restaurant, hotel, resort, etc., the present invention provides for a destination rating of the overall geographic location, including more than one distinct business entity having a physical presence and corresponding goods and services within that geographic location, and associated with a multiplicity of stakeholders.

Business entity and corresponding stakeholders includes business entities, community members, citizens, civic groups, municipalities (including but not limited to local government), government entities, non-profit organizations, hospitality organizations, venues for rent or use (e.g., meeting space, sports arenas, convention centers, etc.), restaurants, entertainment venues, shopping, lodging, attractions, transportation entity, activities, attractions, and combinations thereof. The business entity and stakeholders according to the present invention are not merely virtual service providers for scheduling events, but rather are physically established entities having a geographic commonality with the other business entities and stakeholders associated with a single common destination. By way of example and not limitation, for a single common destination that is a city or town, the more than one business entity includes at least one hotel, at least one restaurant, and at least one municipal or local government entity, and combinations thereof, so that at least two of the at least one business entities are selected from a different type of business category, thereby providing a destination rating considering a diverse array of business entities associated physically with a single, common destination for the purposes of the rating of the destination.

The destination rating is based upon visitor-experience-based evaluations having more than one criterion for rating the destination. The criteria are selected from more than one of a plurality of strategic objectives. Preferably, a scorecard for each of the destinations is generated based upon the framework of strategic objectives (preferably about 7 to about 14 strategic objectives); and then an improvement strategy is generated from these strategic objectives based upon criteria and input from stakeholders and visitors. In one preferred embodiment, approximately seven (7) strategic objectives are provided, including but not limited to visitor-related data collection associated with a visitor pathway, which defines how any visitor may experience a single destination having a multiplicity of business entities and/or stakeholders associated therewith.

The present invention further provides automated systems and methods for transforming a destination rating and ranking into a scorecard based upon a multimetric rating, wherein the rating includes visitor experience-sharing provided based upon data collection associated with user-based profiles and destination-based profiles stored in at least one database and server computer having a processor coupled with a memory, and an analytics engine operable thereon, with a multiplicity of contributors providing inputs for generating a multi-metric rating via a network connection and an interactive graphic user interface on a display and in communication with the server(s).

In automated systems and methods for providing a virtual scorecard for at least one rating and at least one ranking of at least one destination according to the present invention, a multimetric rating for each destination is provided through user-based profiles and destination-based profiles stored in at least one database and server computer having a processor coupled with a memory, and an analytics engine operable thereon, with user access provided through a network via an interactive graphic user interface on a display and in communication with the server(s). In one aspect of embodiments of the present invention a graphic user interface on a display shows an interactive website that provides the scorecard and further includes information about various characteristics of each destination, including a multimetric rating evaluating the destination on more than one criteria, and wherein the overall (single, integral and unitary) destination rating considers more than one business entity associated with the geographic location of the destination. The graphic user interface (GUI) further includes information, data, graphical representation(s) of data, images, and combination thereof. Additionally, the GUI preferably includes input options for visitor users relating to the criteria for evaluating the destination. The GUI may further include input options for visitor users to establish and update a visitor user profile associated with an unique user identification for secure login and access to that visitor user profile and inputs. The GUI may further include input options for stakeholder users to establish and update a corresponding stakeholder user profile associated with an unique user identification for secure login and access to that stakeholder user profile and inputs therefor. The inputs provided by visitor users and stakeholder users via the website GUI are communicated to a remote server computer that is in network-based communication with the input devices that are distributed over the network. The inputs are stored in memory in a database, and are preferably retained for secure access by the visitor and/or stakeholders that made the inputs, i.e., that are associated with their corresponding profiles. In one embodiment of the present invention, an analytics engine operable on the server computer provides for anonymized analysis of the data for providing the rating of the destination, and other analyses of the data collected, including but not limited to time-based trends, mean and median, categorizations, grouping, and analysis compared with target values, and combinations thereof, for a single destination. Also, the analysis reflected with the scorecard may further include comparison or ranking, including but not limited to quantified ranking, qualified ranking, and combinations, comparing more than one destination. Also or alternatively, the analysis may further include an index of ratings for destinations, based on the data collected and analyzed against predetermined values, targets, models, strategic objectives, and combinations thereof. The index of ratings may further include standards-based items for normalizing factors to improve comparative metrics for destinations rated on different criteria.

Additionally, according to embodiments of the present invention for automated systems and methods for destination rating and visitor experience-sharing, the destination rating is provided based upon data collection associated with user-based profiles and destination-based profiles stored in at least one database and server computer having a processor coupled with a memory, and an analytics engine operable thereon, with a multiplicity of contributors providing inputs for generating a multi-metric rating via a network connection and an interactive graphic user interface on a display and in communication with the server(s).

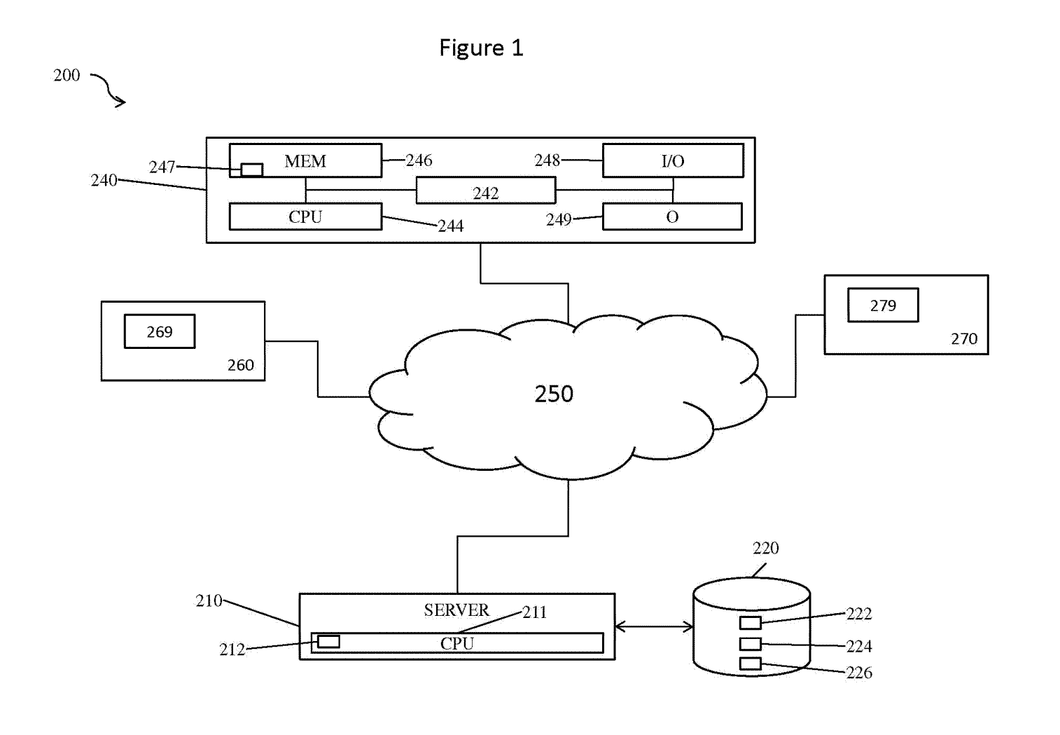

FIG. 1 is a schematic diagram illustrating a virtualized computing network used in of one embodiment of the invention for automated systems and methods. As illustrated, components of the systems and methods include the following components and sub-components, all constructed and configured for network-based communication, and further including data processing and storage. As illustrated in FIG. 1, a basic schematic of some of the key components of a system according to the present invention are shown. The system 200 comprises a server 210 with a processing unit 211. The server 210 is constructed, configured and coupled to enable communication over a network 250. The server provides for user interconnection with the server over the network using a personal computer (PC) 240 positioned remotely from the server. Furthermore, the system is operable for a multiplicity of remote personal computers or terminals 260, 270. For example, a client/server architecture is shown. Alternatively, a user may interconnect through the network 250 using a user device such as a personal digital assistant (PDA), mobile communication device, such as by way of example and not limitation, a mobile phone, a cell phone, smart phone, laptop computer, netbook, a terminal, or any other computing device suitable for network connection. Also, alternative architectures may be used instead of the client/server architecture. For example, a PC network, or other suitable architecture may be used. The network 250 may be the Internet, an intranet, or any other network suitable for searching, obtaining, and/or using information and/or communications. The system of the present invention further includes an operating system 212 installed and running on the server 210, enabling server 210 to communicate through network 250 with the remote, distributed user devices. The operating system may be any operating system known in the art that is suitable for network communication.

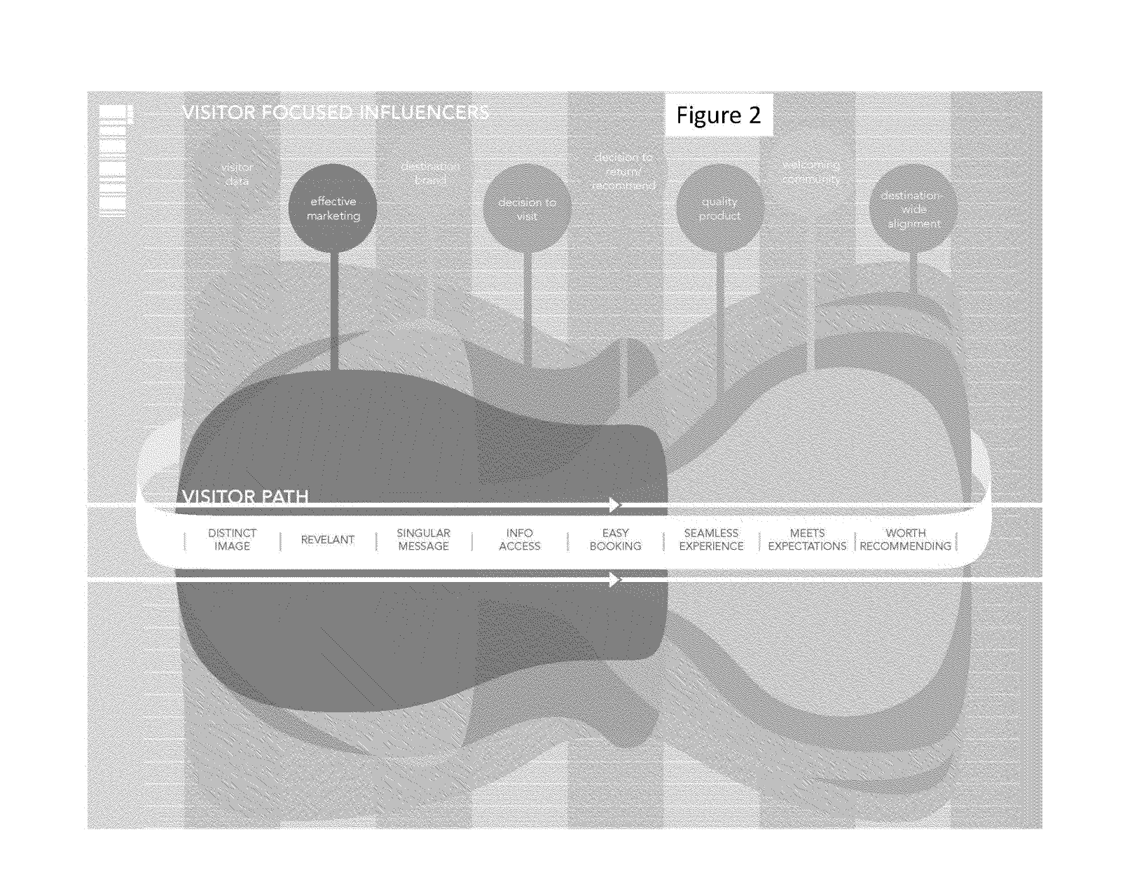

Significantly, when rating a destination to provide an overall, unitary and integral rating for a geographic location including more than one business or other entity, as with the present invention, the visitor data inputs are the most important factors for stakeholders to use for influencing the visitor interpretation of a destination, i.e., of their experience of a destination. Referring now to FIG. 2, a schematic diagram of an embodiment of the invention showing multiple criteria for visitor experience data collection is shown, illustrating more than one criteria, wherein the criteria are labeled as follows: distinct image, relevant, singular message, information access, easy booking, seamless experience, meets expectations, and worth recommending. While the criteria may be considered in any order, in one embodiment of the present invention, these criteria are considered in series along a visitor pathway as illustrated in the FIG. 2, which logically follows a succession of ordered steps for the criteria consideration, which are included in the visitor inputs for data collection that are used for generating the multi-metric rating for the destination.

Additionally, criteria may further include labels for decision to visit and/or decision to return. Stakeholder factors are also provided with the present invention, so that stakeholder users may establish and update profiles and view anonymized visitor profiles and/or visitor rating data associated with their corresponding destination(s). A plurality of visitor-focused influencers provide a strategy and actionable steps that stakeholders can make in order to positively affect and improve the visitor experience and the destination rating. Preferably, the influencers are standardized. Stakeholders are provided through a GUI a plurality of factors included in the strategy for their destination and actionable steps, and the factors relating to visitor rating for their destination are preferably selected from: visitor data, effective marketing, destination brand, decision to visit, decision to return and/or recommend, quality product, welcoming community, destination-wide alignment, and combinations thereof. In embodiments of the present invention, the scorecard or other information associated with each of the destinations, and a comparative ranking of destinations is provided. The comparative ranking of destinations is provided for overall ranking on multiple factors. Additionally, or alternatively, other rankings are provided, wherein each destination is considered and compared automatically to other destinations for a multiplicity of factors, including but not limited to the criteria of visitor data, effective marketing, destination brand, decision to visit, decision to return and/or recommend, quality product, welcoming community, destination-wide alignment, and combinations thereof.

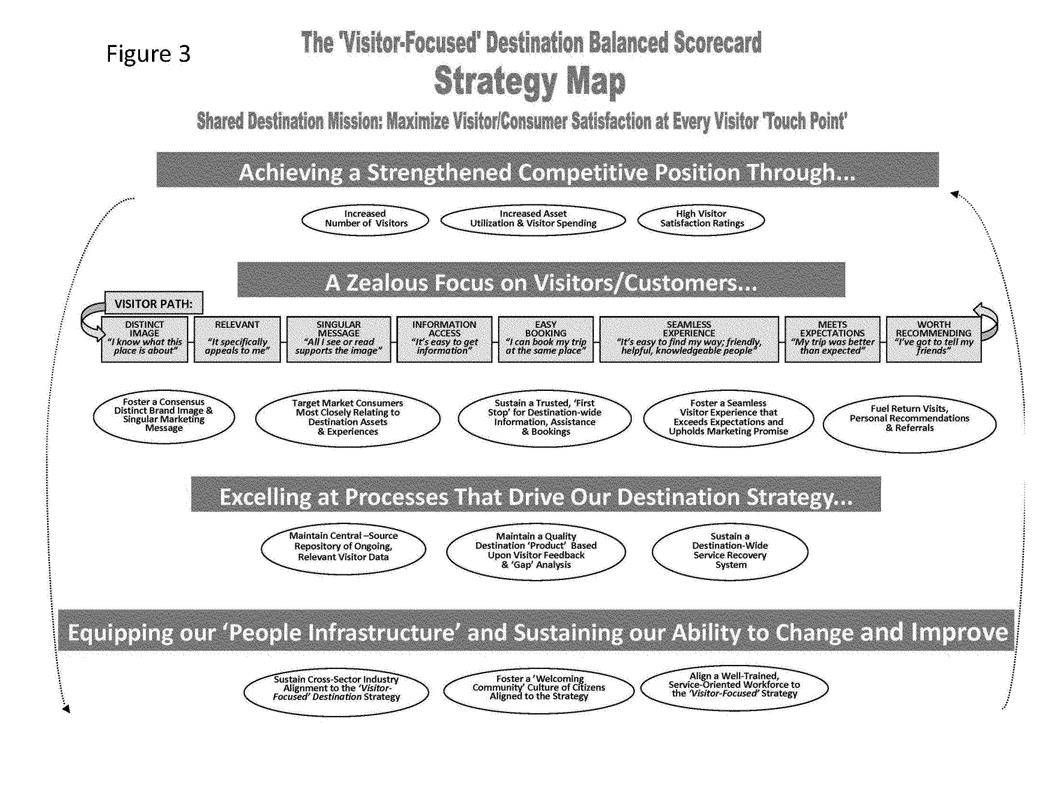

These influencers are foundational for the standards for developing the rating for each destination. FIG. 3 provides a schematic diagram of an embodiment of the invention showing a standards table.

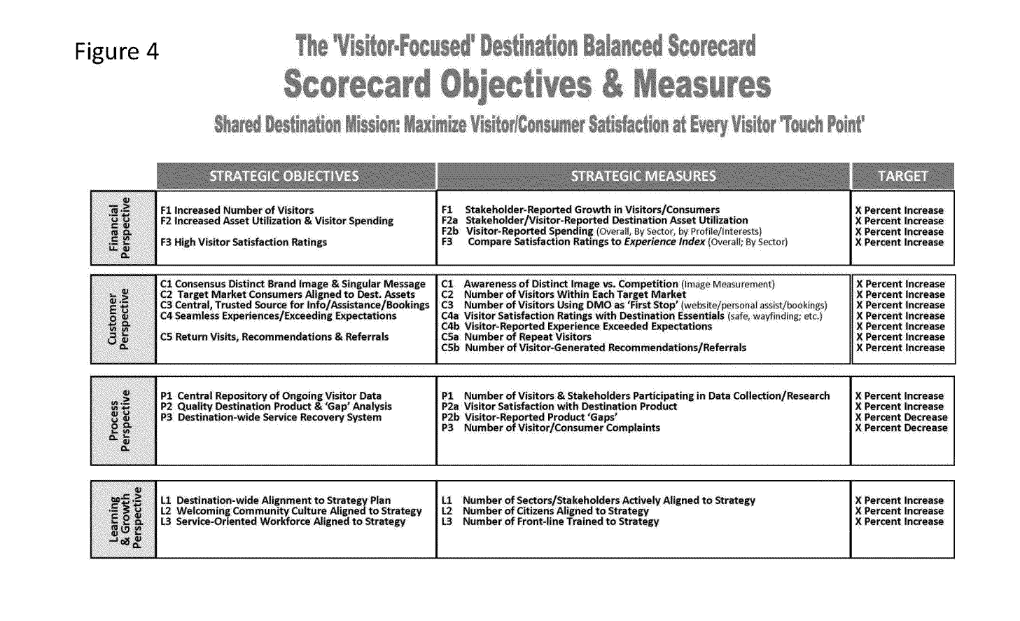

While each influencer is preferably not equally weighted, questions associated with the criteria for visitor rating may overlap categories. Stakeholder data is provided against the criteria as well as visitor data. All stakeholders provide data, which balances with the visitor data inasmuch as it provides a different perspective that completes the scorecard overall picture of the destination. Standardized criteria are important with systems and methods of the present invention. Preferably, the systems and methods of the present invention provide for the criteria to extend from or to be related to the visitor data or pathway. Also, preferably, the standards for a destination to follow for improving the visitor experience. Additionally, as illustrated in FIG. 4, a strategy map for a visitor-focused destination balanced scorecard and standards-based factors for improvement are shown.

Visitor data is the most critical factor that affects an overall rating for a destination, including actionable steps that stakeholders can make individually and collectively to improve the destination rating, including the contribution of each business entity to the overall destination rating. Another important factor that affects an overall rating for a destination relates to stakeholders working together or collaboratively to improve the visitor experience. Thus, stakeholders having secure access to review visitor data collected and analyzed, and anonymized for privacy, in a consistent format, allows stakeholders to communicate and share the visitor data and to determine strategies and actions for alignment of stakeholder interests and coordinate activities, including but not limited to strategy execution including marketing, advertising, customer (visitor) service, community activities promotion and participation by citizens and by the entity constituents, which necessarily involve coordinated communications and activities between and among independent entities, including by way of example and not limitation, business entities, government, organizations, and combinations as set forth hereinabove.

Preferably, a strategic directive and/or objectives and steps or actions for improvement to positively impact the overall destination rating is provided for consideration and participation based upon the stakeholder profiles and inputs, as well as the visitor profiles and inputs (the visitor data). An aggregation of ratings and analysis of individual visitor ratings is provided to stakeholders; also preferably, an index or destination ratings (comparison of the destination rating to an index of factors) and/or a ranking of destinations viewable by the stakeholders is provided.

In methods according to the present invention, steps for generating a scorecard associated with a destination include: providing a web-based interactive site, constructed and configured for remote viewing on computer devices; receiving inputs through the web-based interactive site from at least one user including information about at least one destination; transforming the inputs into factors and categories; generating a virtual scorecard including at least one rating and at least one ranking; and improvements associated with a predetermined strategy, the improvements being specific to a destination, wherein the destination comprises more than one business entity associated with a geographic location, thereby providing an automated virtual experience-sharing and destination rating. Preferably, the improvements are positive changes to the at least one rating and/or the at least one ranking that is generated from inputs associated with one or more of the criterion selected from distinct image, relevant, singular message, information access, easy booking, seamless experience, meets expectations, worth recommending, and combinations thereof.

By contrast to the prior art, the present invention provides for standardized criteria for evaluating a destination that provides for optimum quantifiable ratings, so that the nature of the rating is predominantly or completely objective, rather than subjective (as in prior art). Visitor data includes fact-based inputs, rather than unstructured inputs or opinions by visitors, as with sites like www.yelp.com and www.tripadvisor.com. Furthermore, contextualization of the questions, i.e., analytical consideration of the visitor user profiles and the visitor user inputs provides a comprehensive perspective of the rating for the destination for a single visitor user. Aggregation of ratings for a multiplicity of visitor users, or a multiplicity of visitor contributors providing the same visitor data, which includes objective answers to the exact same questions presented to visitor users for each destination considered for rating by the visitor user is provided in the present invention systems and methods. While the standardized questions are the same for visitors, not all visitors are exposed to all of the questions.

Certain modifications and improvements will occur to those skilled in the art upon a reading of the foregoing description. By way of example, while the foregoing description provides for embodiments having websites associated with a network such as the internet, alternatively, a private network may be used. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. An automated system for virtual experience-sharing and destination rating comprising:
a web-based interactive site, constructed and configured for remote viewing on computer devices;
a scorecard including at least one rating and at least one ranking, and improvements associated with an improvement strategy, the improvements being specific to a destination; and
wherein the destination comprises more than one business entity associated with a geographic location, thereby providing subjective experience-sharing in an objective and systematic format.

2. The system of claim 1, wherein the web-based interactive site includes more than one criterion for evaluating the destination.

3. The system of claim 2, further including a multimetric rating for the destination, wherein the evaluation criteria are integrated automatically for determining the multimetric rating.

4. The system of claim 2, wherein the web-based interactive site is further constructed and configured for receiving the evaluation criteria from a multiplicity of contributors.

5. The system of claim 1, further including profiles for destinations.

6. The system of claim 1, further including profiles for users.

7. The system of claim 1, further including automated matching between profiles for destinations and for users.

8. The system of claim 1, wherein the web-based interactive site further includes a graphic user interface for receiving inputs and for displaying information and graphics associated with the multimetric rating.

9. The system of claim 2, wherein the criteria are selected from at least seven items associated with a visitor experience for the destination.

10. The system of claim 1, wherein the multimetric rating further comprises factors selected from: distinct image, relevant, singular message, information access, easy booking, seamless experience, meets expectations, worth recommending, and combinations thereof.

11. The system of claim 1, wherein the information further includes user ratings and feedback.

12. The system of claim 1, wherein the improvement strategy further includes a listing of actions for alignment of stakeholder interests and coordination of activities for improving the scorecard associated with the destination.

13. The system of claim 13, wherein the improvement strategy further includes strategy execution factors including marketing, advertising, customer service, community activities promotion, and/or participation by citizens and by entity constituents.

14. The system of claim 1, wherein the web-based interactive site further includes a graphic user interface for automatically displaying information and graphics associated with the multi-metric rating and the scorecard.

15. The system of claim 1, wherein the multi-metric rating is generated from inputs associated with criteria selected from distinct image, relevant, singular message, information access, easy booking, seamless experience, meets expectations, worth recommending, and combinations thereof.

16. The system of claim 15, wherein the criteria is cross-referenced with influencers.

17. The system of claim 15, wherein the multimetric rating is generated from inputs associated with more than two criteria.

18. The system of claim 15, wherein the multimetric rating is generated from inputs associated with at least seven criteria.

19. A method for virtual experience-sharing and destination rating comprising the steps of:
providing a web-based interactive site, constructed and configured for remote viewing on computer devices;
receiving inputs through the web-based interactive site from at least one user including information about at least one destination;
transforming the inputs into factors and categories;
generating a virtual scorecard including at least one rating and at least one ranking; and
wherein improvements are associated with a predetermined strategy, the improvements being specific to a destination, wherein the destination comprises more than one business entity associated with a geographic location, thereby providing an automated virtual experience-sharing and destination rating.

20. The method of claim 19, wherein the at least one rating further includes a multimetric rating that is generated from inputs associated with criteria selected from distinct image, relevant, singular message, information access, easy booking, seamless experience, meets expectations, worth recommending, and combinations thereof.
